(19) United States
(12) Patent Application Publication
(10) Pub. No.: US 2010/0128159 A1
(43) Pub. Date: May 27, 2010

(54) IMAGING APPARATUS AND ITS DRIVE CONTROLLING METHOD

(76) Inventor: Hayato YAMASHITA, Miyagi (JP)

Correspondence Address: BIRCH STEWART KOLASCH & BIRCH, PO BOX 747, FALLS CHURCH, VA, 22040-0747, US

(21) Appl. No.: 12/626,273

(22) Filed: Nov. 25, 2009

(30) Foreign Application Priority Data
Nov. 27, 2008 (JP) P2008-302780

(51) Int. Cl. H04N 5/335; H04N 5/235

(52) U.S. Cl. 348/311; 348/362; 348/E05.091; 348/E05.037

(57) ABSTRACT

An imaging apparatus includes a solid-state imaging device and an imaging device driver. The imaging device includes first pixels and second pixels. The first pixels execute an imaging operation for a long exposure time. The second pixels execute an imaging operation for a short exposure time which overlaps with a part of the long exposure time. The first and second pixels are mixedly arranged in a two dimensional array. Plural different drive controlling modes each controlling operation timings of start and end of exposure of the first pixels and operation timings of start and end of exposure of the second pixels are prepared in advance. The imaging device driver selects one of the drive controlling modes in accordance with a shooting condition under which an object image is taken and drives the solid-state imaging device in accordance with the selected mode.

### CROSS-REFERENCE TO RELATED APPLICATIONS

This application claims the benefit of Japanese Patent Application No. 2008-302780, filed Nov. 27, 2008, the entire contents of which are hereby incorporated by reference, the same as if set forth at length.

### BACKGROUND

1. Technical Field

The invention relates to an imaging apparatus capable of taking an object image with a wide dynamic range and its drive controlling method.

2. Related Art

JP 2003-219281 A describes an imaging apparatus that can take an object image with a wide dynamic range. This imaging apparatus includes a CCD-type solid-state imaging device to execute short-exposure-time imaging using all pixels and subsequently execute long-exposure-time imaging using all the pixels so that image data obtained by both imaging processes are combined, to thereby extend the dynamic range of the object image.

However, in this imaging apparatus, the short-exposure-time imaging and the long-exposure-time imaging don't overlap in time. Therefore, a time difference will occur between the image taken by the short-exposure-time imaging and the image taken by long-exposure-time imaging.

In an imaging apparatus described in JP 2007-235656 A, all pixels of a CCD imaging device are divided into high-sensitivity imaging pixels and low-sensitivity imaging pixels alternately arranged every one row. The high-sensitivity imaging pixels are exposed for a long time, and the low-sensitivity imaging pixels are exposed only for a short time during the long exposure time. Object images obtained by the both kinds of pixels are combined to be synthesized, to thereby extend the dynamic range of the object image.

In this imaging apparatus, the long exposure time and the short exposure time overlap with each other. Therefore, no time difference will occur between the both kinds of images. However, since both a shutter time for the short exposure and that for the long exposure are controlled by an electronic shutter, if a signal charge read out to a vertical charge transferred after completion of the short-time exposure is caused to stay there for a long time until the long exposure time is completed, a smear component contained in an imaging up signal provided by the short exposure time might increase.

### SUMMARY OF THE INVENTION

In an imaging apparatus in which pixels of a solid-state imaging device are divided into long-exposure-time pixels and short-exposure-time pixels and an image taken by the long exposure time and an image taken by the short exposure time, which overlaps with the long exposure time, are synthesized, both of the mechanical shutter and the electronic shutter may be employed to reduce the smear.

However, the mechanical shutter has a limit in accuracy because it is mechanical. Therefore, it is necessary to set up a method for combing the mechanical shutter and the electronic shutter in response to shooting conditions.

For example, where exposure for the short exposure time is terminated using the mechanical shutter with its operation assured to 1/1,000 sec., the short exposure time of 1/1,000 sec or less cannot be realized accurately. Further, where “a ratio of the short exposure time to the long exposure time=1:10” is realized, the executing limit of the short exposure time is 1/1,000 sec., the long exposure time has a limit of 1/100 sec. Therefore, the long exposure time shorter than this limit cannot be realized.

The invention provides an imaging apparatus that can appropriately switch between the mechanical shutter and the electronic shutter according to a shooting condition, so that a high-quality image which is less influenced by smears can be obtained even if an object image with a wide dynamic range is obtained, and its drive controlling method.

According to an aspect of the invention, an imaging apparatus includes a solid-state imaging device and an imaging device driver. The solid-state imaging device includes a plurality of first pixels and a plurality of second pixels. The first pixels execute an imaging operation for a long exposure time. The second pixels execute an imaging operation for a short exposure time which overlaps with a part of the long exposure time. The first and second pixels are mixedly arranged in a two dimensional array. Charge transfer paths are formed along a plurality of pixel columns composed of the first and second pixels, respectively. A plurality of different drive controlling modes each controlling operation timings of start and end of exposure of the first pixels and operation timings of start and end of exposure of the second pixels are prepared in advance. The imaging device driver compares a length of an exposure time which is determined based on a shooting condition under which an object image is taken with a predetermined threshold value, selects one of the plurality of different drive controlling modes in accordance with the comparison result, and drives the solid-state imaging device in accordance with the selected mode.

According to another aspect of the invention, there is provided a drive controlling method for an imaging apparatus including a solid-state imaging device. The solid-state imaging device includes a plurality of first pixels and a plurality of second pixels. The plurality of first pixels execute an imaging operation for a long exposure time. The plurality of second pixels execute an imaging operation for a short exposure time which overlaps with a part of the long exposure time. The first and second pixels are mixedly arranged in a two dimensional array. Charge transfer paths are formed along a plurality of pixel columns composed of the first and second pixels, respectively. A plurality of different drive controlling modes each controlling operation timings of start and end of exposure of the first pixels and operation timings of start and end of exposure of the second pixels are prepared in advance. The derive controlling method includes: comparing a length of an exposure time which is determined based on a shooting condition under which an object image is taken with a predetermined threshold value; and selecting one of the plurality of different drive controlling modes in accordance with the comparison result.

In accordance with the above configuration and method, a high-quality image which is less influenced by smears can be obtained even if an object image having a wide dynamic range is obtained.

### BRIEF DESCRIPTION OF THE DRAWINGS

FIG. 1 is a block diagram of an imaging apparatus according to an embodiment of the invention.

FIG. 2 is a surface schematic view of a solid-state imaging device shown in FIG. 1.

FIG. 3 is a functional arrangement view of an imaging device driver of the imaging apparatus when an object image with a wide dynamic range is taken.

FIG. 4 is a flowchart showing an imaging procedure executed by CPU shown in FIG. 1.

FIG. 5A is an operation timing chart of drive control which is selected and executed when a short exposure time<a predetermined threshold value.

FIG. 5B is an operation timing chart of the drive control which is selected and executed when the short exposure time the predetermined threshold value.

FIG. 6 is an operation timing chart showing drive control different from that shown in FIG. 5.

FIG. 7 is a surface schematic view of a solid-state imaging device according to an embodiment different from that shown in FIG. 2.

### DETAILED DESCRIPTION OF EMBODIMENTS OF THE INVENTION

Now referring to the drawings, embodiments of the invention will be described below.

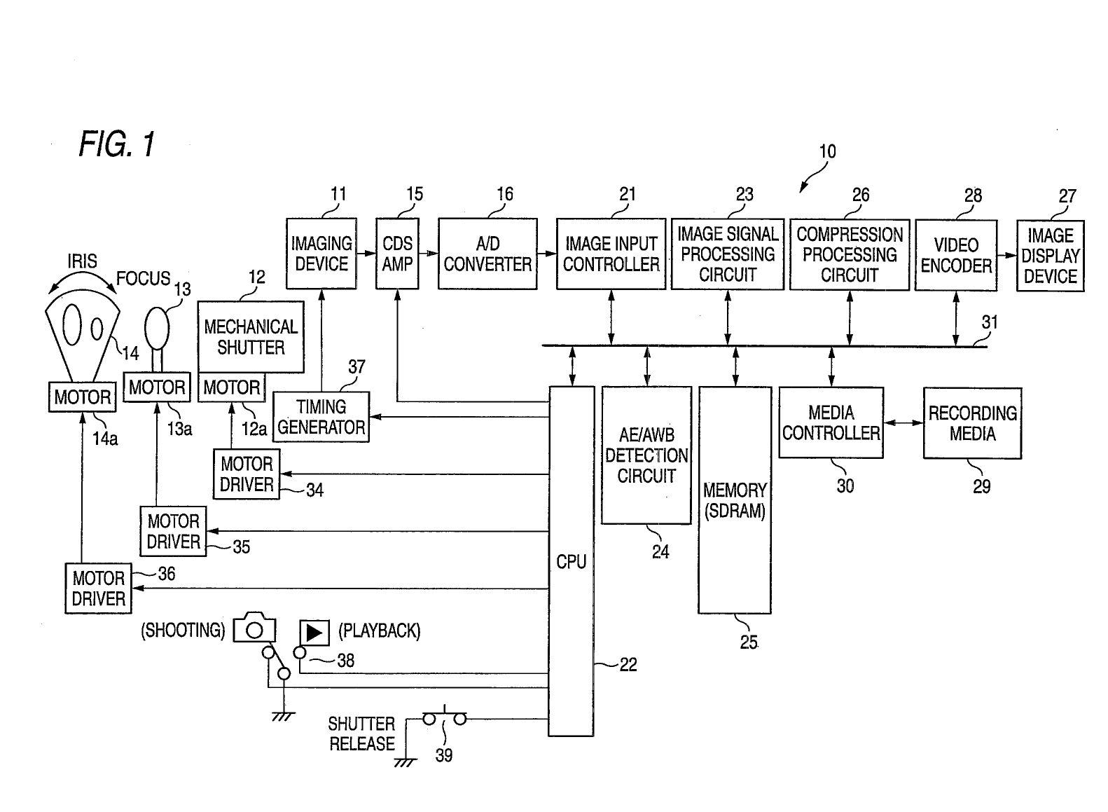

FIG. 1 is a block diagram of an imaging apparatus according to one embodiment. This imaging apparatus (in this embodiment, a digital still camera) 10 includes a CCD-type solid-state imaging device 11, a mechanical shutter 12 which is provided ahead of the solid-state imaging device 11, an imaging lens 13, an diaphragm (iris) 14, a CDSAMP (correlated double sampling (CDS), a gain control amplifier (AMP)) 15 which performs analog signal processing for an output signal (taken image signal) from the imaging device 11 and an analog/digital (A/D) converter 16 which converts an output signal from the CDSAMP 15 into a digital signal.

The imaging apparatus 10 further includes an image input controller 21, a central processing unit (CPU) 22, an image signal processing circuit 23, an AE/AWB detection circuit 24, an SDRAM 25, a compression processing circuit 26, a video encoder 28, a media controller 30 and a bus 31. The image input controller 21 acquires the taken image signal, which is the digital signal output from the A/D converter 16. The CPU 22 controls the overall of the imaging apparatus 10. The image signal processing circuit 23 performs image processing for the taken image signal. The AE/AWB detection circuit 24 automatically detects an amount of exposure light and white balance. The SDRAM 25 serves as a storage device which is used as an image processing working memory and stores an imaging device driving signal file (which will be described later) in advance. The compression processing circuit 26 compresses taken image data, which have been subjected to the image processing, into a JPEG image, an MPEG image or the like. The video encoder 28 displays the taken image or a live view image on a liquid-crystal display device 27 provided on the back of the camera. The media controller 30 stores the taken image data in a recording media 29. The bus 31 interconnects the above described components.

The imaging apparatus 10 further includes a motor driver 34, a motor driver 35, a motor driver 36 and a timing generator 37. The motor driver 34 supplies a driving pulse to a driving motor 12a of the mechanical shutter 12. The motor driver 35 supplies a driving pulse to a motor 13a for driving a focus lens position of the imaging lens 13. The motor driver 36 supplies a driving pulse to a driving motor 14a for controlling an diaphragm position of the diaphragm 14. The timing generator 37 supplies driving timing pulses (inclusive of an electronic shutter pulse, a reading pulse, a transfer pulse, etc.) to the solid-state imaging device 11. These components operate based on commands from CPU 22. Further, the CDSAMP 15 also operates based on a command form CPU 22.

CPU 22 is further connected to a switch 38 for switching between a shooting mode and a playback mode and a shutter release button 39 for a two-stage shutter (S1, S2). CPU 22 controls the imaging apparatus 10 based on a user's instruction input through these switches 38, 39.

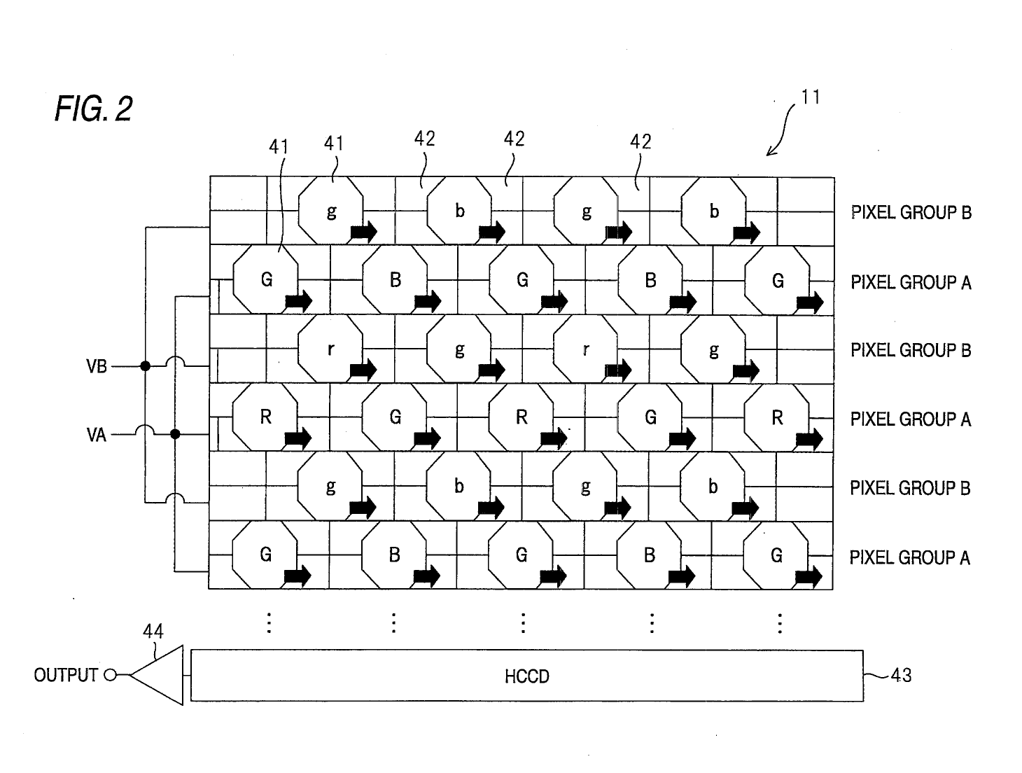

FIG. 2 is a surface schematic view of the CCD-type solid-state imaging device 11 shown in FIG. 1. The solid-state imaging device 11 includes a plurality of photodiodes (octagonal segments illustrated in the figure, hereinafter also referred to as “pixels”) 41 which are arranged in a two-dimensional array (checkered pattern in the illustrated example) on a surface of a semiconductor substrate.

Assuming that a group of photodiodes at even rows are referred to as a pixel group A and that a group of photodiodes at odd rows are referred to as a pixel group B, the pixel group A and the pixel group B are displaced by ½ pixel with respect to each other, thereby forming a “honeycomb pixel arrangement” as a whole.

When attention is only given to the pixel group A, the pixels 41 are arranged in a square grid pattern. Color filters having the three primary colors of red (R), green (G) and blue (B) are arranged over the respective pixels 41 in the Bayer pattern. Also, when attention is only given to the pixel group B, the pixels 41 are arranged in a square grid pattern. Color filters having the three primary colors of red (r), green (g) and blue (b) are arranged over the respective pixels 41 in the Bayer pattern. Although “R, G, B” and “r, g, b” are the same colors, respectively, in order to distinguish the pixel group A and the pixel group B from each other, the colors of the color filters are distinguished using capital letters and small letters.

Along the respective columns of the pixels, vertical charge transfer paths (VCCD) 42 each is formed to meander. A horizontal charge transfer path (HCCD) 43 is formed along ends of the respective vertical charge transfer paths 42 in the transfer direction. At an output end of the horizontal charge transfer 43, an amplifier 44 is provided to output, as a taken image signal, a voltage value signal corresponding to a charge amount of signal charges transferred.

In each pixel 41, two vertical transfer electrodes are provided. Of these vertical transfer electrodes, in the illustrated example, the transfer electrode on the lower side (HCCD 43 side) also serves as a reading electrode. With this connection configuration, a reading pulse VA is commonly applied to the reading electrodes of the pixel group A, and a reading pulse VB is commonly applied to the reading electrodes of the pixel group B. Specifically, in the figure, charges (signal charge) accumulated in each pixel 41 are read out in the direction indicated by a black arrow and transferred to a potential well formed below the reading electrode corresponding to each pixel 41.

In the following description, it is assumed that the pixel group A is a group of pixels for long exposure time, and that the pixel group B is a group of pixels for short exposure time.

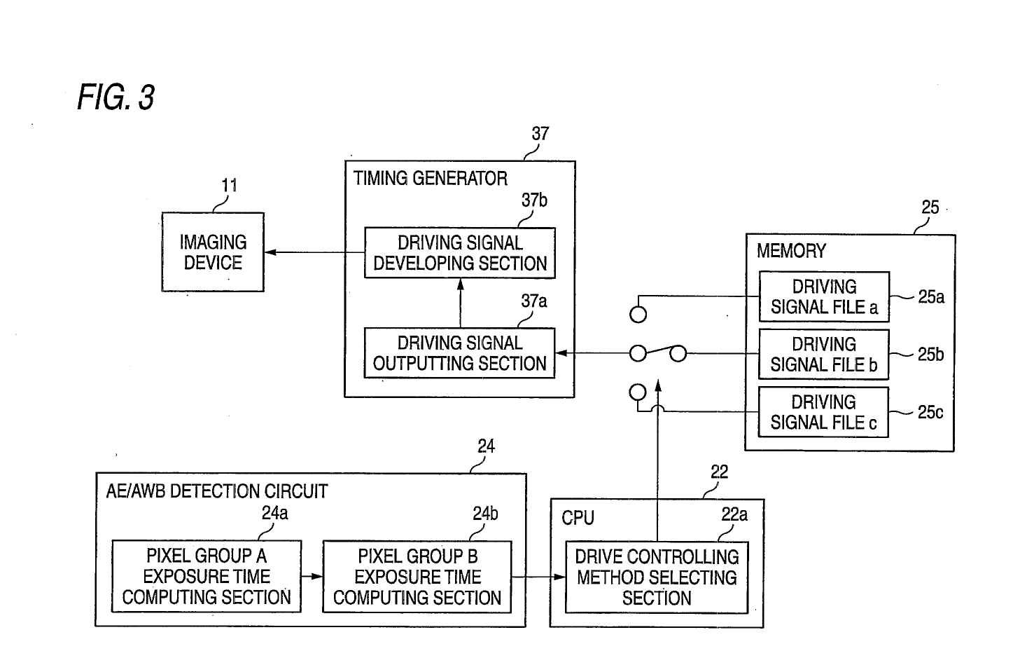

FIG. 3 is a functional arrangement view of an imaging device driver when the imaging apparatus 10 shown in FIG. 1 takes an object image having a wide dynamic range. The memory (SDRAM) 25 stores, in advance, plural kinds of files (for example, a file a (25a), a file b (25b) and a file c (25c)) as driving signal files for driving the solid-state imaging device 11.

The solid-state imaging device 11 outputs a predetermined number of frames of image data per 1 second even in a state where the shutter release button is not depressed. The image signal processing circuit 23 successively performs the signal processing for the image data so as to display the image data as a live view image on an image display device 27. The AE/AWB detection circuit 24 analyzes the image data for the live view image acquired from the solid-state imaging device 11, and an exposure time computing section 24a computes an exposure time corresponding to the exposure amount.

In the imaging apparatus 10 according to this embodiment, this exposure time is regarded as an exposure time (long exposure time) for the pixel group A, and an exposure time computing section 24b computes a short exposure time corresponding to this long exposure time. A time ratio “long exposure time: short exposure time=n:1” is obtained based on a dynamic range width designated and input by a user or a dynamic range width which is automatically determined by having the imaging apparatus 10 analyze the live view image data. Then, the short exposure time is computed based on this time ratio.

A driving method selecting section 22a of CPU 22 selects any one of the files a, b and c in the memory 25 based on the computing result (the long exposure time and short exposure time computed by the AE/AWB detection circuit 24) and outputs data of the selected file to the timing generator 37.

In the timing generator 37, a driving signal developing section 37a develops the imaging device driving signal contained in the received file, and a driving signal outputting section 37b creates an imaging device driving pulse and outputs it to the solid-state imaging device 11.

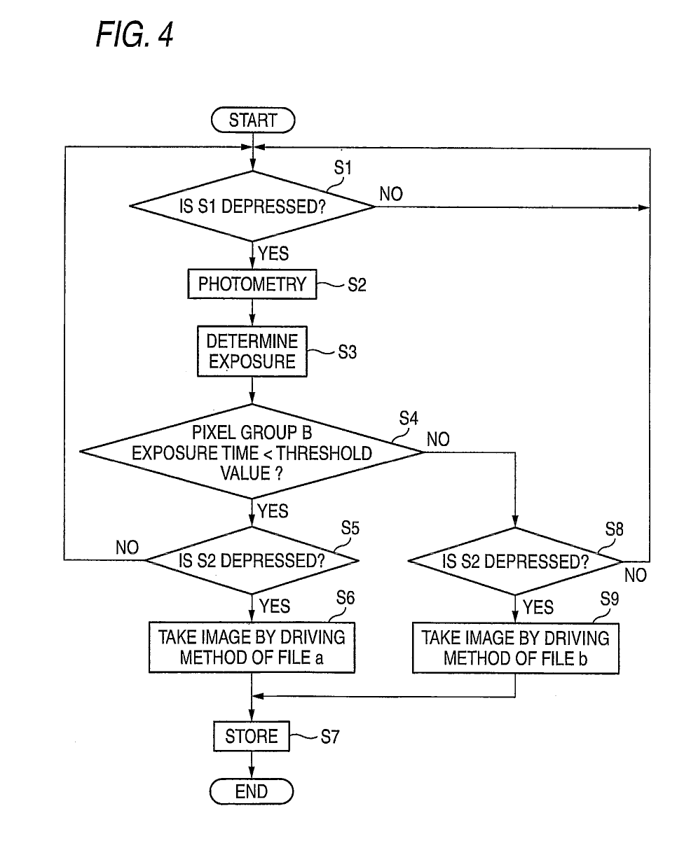

FIG. 4 is a flowchart showing the imaging procedure of the imaging apparatus 10 shown in FIG. 1. In the above description, it is assumed that the AE/AWB detection circuit 24 selects one of the files a, b and c according to the shooting condition. However, in FIG. 4, for simplicity of explanation, it is assumed that one of the files a and b is selected.

First, CPU 22 determines as to whether or not the release button 39 of the two-stage shutter is half-depressed, that is, whether or not the first switch S1 is depressed (step S1). If the release button 39 is half depressed, the procedure proceeds to next step S2 to conduct photometry. The photometry is done in such a manner that the image data output from the solid-state imaging device 11 as the live view image is acquired and analyzed.

In next step S3, exposure is determined based on the result of the photometry. Specifically, the long exposure time (shutter speed) for the pixel group A and the aperture amount of the diaphragm 14 are determined. Furthermore, the short exposure time for the pixel group B is determined.

In next step S4, it is determined as to whether or not the short exposure time determined at the step S3 is shorter than a predetermined threshold value. Based on the determination result, the procedure is branched. The predetermined threshold value is determined considering an operation accuracy of the mounted mechanical shutter 12.

If the short exposure time is shorter than the predetermined threshold value (Yes at step S4), it is determined that the mechanical shutter cannot end the exposure with high accuracy, and the procedure waits for the fully-depressed state of the shutter, that is, depression of the second switch S2 (step S5). If the second switch S2 is not depressed (No at step S5), that is, if a user detaches his/her finger from the shutter button or if it takes a long time until the switch S2 is depressed, the procedure returns to step S1 to execute the photometry in step S2 again.

If the short exposure time is shorter than the predetermined threshold value (Yes at step S4) and if the shutter button is fully depressed (Yes at step S5), the file a, that is, a driving method of not ending the short exposure time by the mechanical shutter (which will be described later) is selected from the memory 25, and an image is taken under the drive control based on the file a (step S6). The image data taken is stored in the recording medium 29, for example, in the JPEG form (step S7). In this way, the procedure is ended.

If the determination in step S4 is “No”, that is, if the short exposure time is longer than the predetermined threshold value, the procedure proceeds to step S8 in which the same processing as step S5 (waiting for depression of the switch S2) is executed.

If it is determined in step S8 that the switch S2 is depressed (Yes at step S8), the file b, that is, a driving method of ending the short exposure time by the mechanical shutter (which will be described later) is selected from the memory 25, and an image is taken under the drive control based on the file b (step S9). The image data taken is stored in the recording media 29 in step S7, for example, in the JPEG form. In this way, the procedure is completed.

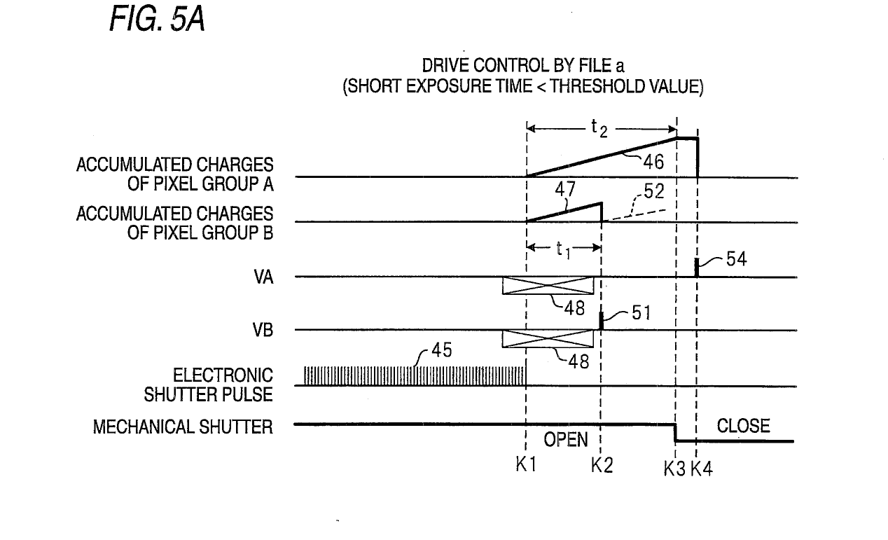

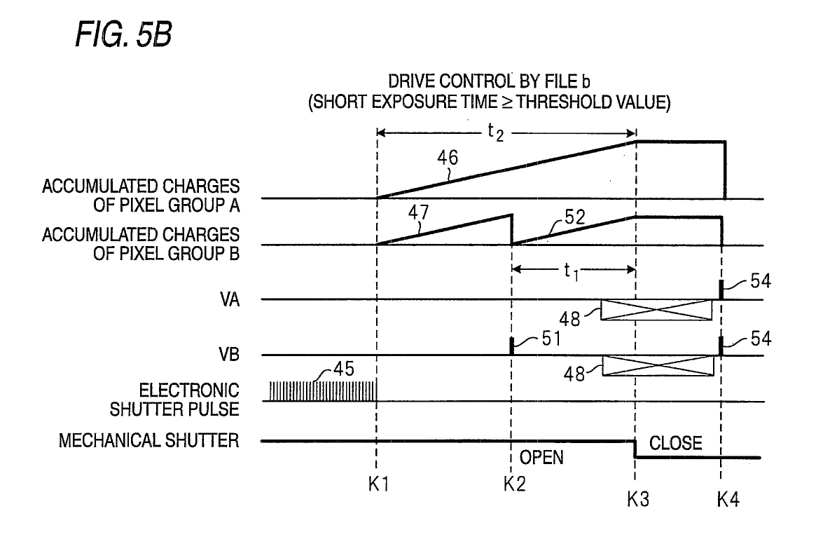

FIG. 5A is an operation timing chart of the drive controlling method based on the file a. FIG. 5B is an operation timing chart of the drive controlling method based on the file b.

If “the short exposure time<the predetermined threshold value (in the case of FIG. 5A), higher control accuracy is achieved by electronically ending the exposure time than ending the short exposure time by the mechanical shutter. Further, since the exposure time is short, mixing of smears can be controlled even without using the mechanical shutter.

So, in the file a, application of an electronic shutter pulse 45 is stopped at an exposure start timing k1, and exposure of the pixel group A for the long exposure time and exposure of the pixel group B for the short exposure time are started. Thereby, electric charges 46, 47 are accumulated in the pixels of the pixel group A, B of FIG. 5A according to the exposure amount.

Concurrently with this exposure, a high-speed sweeping pulse 48 is applied to each transfer electrode on the vertical charge transfer paths 42 shown in FIG. 2 to sweep away electric charges remaining on the vertical charge transfer paths 42. If the short exposure time is too short, there may be a case where this sweeping is not in time. Therefore, as shown in the figure, the sweeping may be started prior to the exposure start timing k1.

At a timing k2 at which the short exposure time t1 has elapsed since the exposure start timing k1, a reading pulse 51 is applied to the reading electrodes of the pixel group B shown in FIG. 2. Thus, the charges accumulated in each pixel of the pixel group B are read out into the potential wells under the reading electrodes of the corresponding vertical charge transfer path. Since the exposure continues even after reading, charges 52 are accumulated in each pixel of the pixel group B from which the accumulated charges were read out to the vertical charge transfer path. The charges 52, however, are discarded toward the substrate side by the electronic shutter pulse 45 for a next shooting.

After the short exposure time t1 elapses, at a timing k3 at which the long exposure time t2 has elapsed since the exposure start timing k1, the mechanical shutter 12 is “closed”. Thereby, the exposure time t2 for each pixel of the pixel group A is ended.

At a next timing k4, when a reading pulse 54 is applied to the reading electrodes of the pixel group A, the charges accumulated in the pixels of the pixel group A are read out into the potential wells under the corresponding reading electrodes. Hereinafter, when a vertical transfer pulse is applied to the vertical charge transfer paths 42, (i) the signal charges of the pixel group A and (ii) those of the pixel group B, which have already been read out to the vertical charge transfer paths, are transferred and output.

During a period from the timing k2 to the timing k3, the signal charges in the pixels of the pixel group B stay on the vertical charge transfer paths with the mechanical shutter being “opened”. Therefore, any smear charges might be mixed. However, if the short exposure time is short, the file a is adopted, and if the short exposure time is short, the corresponding long exposure time is also short. Therefore, an amount of smear charges which might be mixed is small, which would not lead to deterioration of the image quality.

The signal charges of the pixels of the pixel group A and the signal charges of the pixels of the pixel group B may be mixed/synthesized during image processing after they are read out from the solid-state imaging device 11 to obtain the taken image signals. Otherwise, the signal charges of the pixels of the pixel group A and the signal charges of the pixels of the pixel group B may be mixed/synthesized on the transfer paths during their transfer. In any way, the object image data having the wide dynamic range can be obtained.

If “the short exposure time the predetermined threshold value” (in the case of FIG. 5B), ending the short exposure time by the mechanical shutter rather eliminates smear mixing in principle.

Therefore, in the file b, application of an electronic shutter pulse 45 is stopped at exposure start timing k1, and exposure of the pixel group A for the long exposure time and exposure of the pixel group B for the short exposure time are started. Thus, electric charges 46, 47 are accumulated in the pixels of the pixel group A, B of FIG. 5B according to the exposure amount.

At a timing k2 at which a required time (a long exposure time t2—a short exposure time t1) has elapsed since the exposure start timing k1, the reading pulse 51 is applied to the reading electrodes of the pixel group B shown in FIG. 2. Thereby, the charges accumulated in the pixels of the pixel group B are read out into the potential wells under the reading electrodes of the corresponding vertical charge transfer path. From this timing k2, signal charges 52 will be newly accumulated in the pixels of the pixel group B.

At a timing k3 at which the short exposure time t1 has elapsed since the timing k2 (simultaneously, the long exposure time t2 has elapsed since the exposure start timing k1), the mechanical shutter 12 is “closed”. Thereby, the long exposure time t2 of the pixel group A is ended, and also the short exposure time t1 of the pixel group B is ended.

In advance of ending of the exposure, the high-speed sweeping pulse 48 is applied to the transfer electrodes on the vertical charge transfer paths 42 shown in FIG. 2 to sweep away the electric charges remaining on the vertical charge transfer paths 42 and accumulated charges of the pixel group B which were read out at the timing k2.

If the reading pulse 54 is applied simultaneously to the reading electrodes of the pixel group A and those of the pixel group B at a timing k4 at which the high speed sweeping on the vertical charge transfer paths is completed, the accumulated charges in the pixels of the pixel group A and the pixels of the pixel group B are read out in the potential wells under the corresponding reading electrodes. Hereinafter, when the vertical transfer pulse is applied to the vertical charge transfer paths 42, the signal charges of the pixel group A and those of the pixel group B are transferred and output.

The signal charges of the pixels of the pixel group A and those of the pixels of the pixel group B may be mixed/synthesized during image processing after they are read out from the solid-state imaging device 11 to obtain taken image signals. Alternatively, they may be mixed/synthesized on the transfer paths during their transfer. In any way, the object image data having the wide dynamic range can be obtained.

In this embodiment, the signal charges in the pixel group A and those in the pixel group B are both read out to the vertical charge transfer paths with the mechanical shutter being “closed” and transferred. Therefore, smear mixing becomes theoretically zero, and the taken image having high quality and wide dynamic range can be obtained.

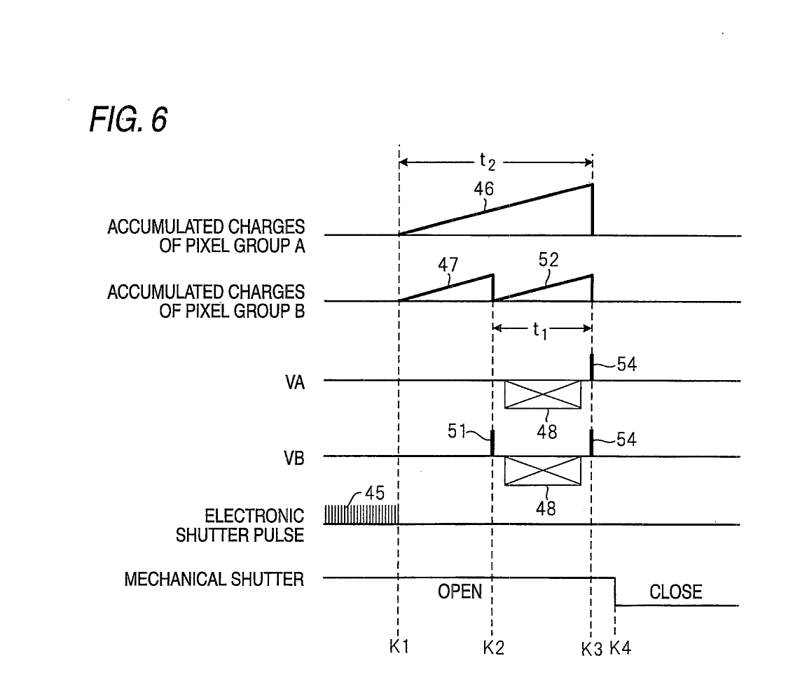

FIG. 6 is an operation timing chart showing the drive controlling method based on the file c. In FIG. 4, switching control between two files of the file a and the file b is explained. The switching control may be done among three files of the file a, the file b and the file c. Further, the switching control may be done between two files of the file a and the file c or between two files of the file b and the file c.

The drive controlling method based on the file a (FIG. 5A) is suitable for the control of the shortest exposure time, and the drive controlling method based on the file b (FIG. 5B) is suitable for the control of the longer short exposure time, whereas this drive controlling method based on the file c is suitable for the intermediate short exposure time between the file a and the file b. This method electronically closes the shutter to endboth of the short exposure time and the long exposure time, without using the mechanical shutter.

First, when application of the electronic shutter pulse 45 is stopped at a timing k1, the exposure of both the pixel group A and the pixel group B is started. Then, the electric charges 46, 47 are accumulated in the pixels for the long exposure time and the pixels for the short exposure time.

At a timing k2 at which a required time (long exposure time t2—short exposure time t1) has elapsed since the exposure start timing k1, the reading pulse 51 is applied to the reading electrodes of the pixel group B shown in FIG. 2. Thereby, the charges accumulated in the pixels of the pixel group B are read out into the potential wells under the reading electrodes of the corresponding vertical charge transfer path. From this timing k2, the signal charges 52 are newly accumulated in the pixels of the pixel group B. The signal charges of the pixel group B read out to the vertical charge transfer paths at timing k2 are discarded by the high speed sweeping pulse 48 which is applied to the vertical charge transfer path 42 after the timing k2.

At a timing k3 at which the short exposure time t1 has elapsed since the timing k2 (simultaneously, the long exposure time t2 has elapsed since the exposure start timing k1) and the high speed sweeping pulse 48 has been applied, if the reading pulse 54 is applied to the reading electrodes of the pixel group A and the reading electrodes of the pixel group B on the vertical charge transfer paths, the accumulated charges in the pixels of the pixel groups A, B are read out into the potential wells formed under the corresponding reading electrodes. At a subsequent timing k4, the mechanical shutter 12 is “closed”. Thereby, the signal charges on the vertical charge transfer paths are transferred with the smear charge being not mixed. Accordingly, the taken image signal is output as described above, and the object image data having the wide dynamic range are produced.

In the file c, between the timing k2 and the timing k3, sweeping of the vertical charge transfer paths is required to be done using the high speed sweeping pulse 48. In this case, as the number of transfer stages in the vertical charge transfer increases, the time taken for the high speed sweeping become longer, which thus requires a longer time.

Specifically, there is a limitation that the short exposure time t1 cannot be made shorter than the time necessary for the high speed sweeping. Therefore, the controlling of further shortening the short exposure time is more difficult than in the case of the file a. However, since the both exposure times are controlled by the electronic shutter capable of achieving higher control accuracy, the dynamic range width, that is, the ratio of the short exposure time to the long exposure time can be controlled with high accuracy. In addition, since the signal charges are transferred after the mechanical shutter is closed, it is possible to easily avoid smear mixing.

In the embodiments described above, description has been given based on the example of so called “progressive reading” for simultaneously transferring and outputting the signal charges in the pixels of the pixel group A and the pixels of the pixel group B. However, since the signal charges are transferred after the mechanical shutter is closed, it is needless to say that the driving method of transferring/outputting the signal charges of the pixel group A and pixel group B by different fields may be adopted.

In step S4 in FIG. 4, the driving method is selected by comparing the short exposure time with the predetermined threshold value. However, the driving method may be selected considering the long exposure time in addition to the short exposure time. Further, since the ratio between the long exposure time and the short exposure time is determined based on the dynamic range width required, the driving method may be selected only using the long exposure time.

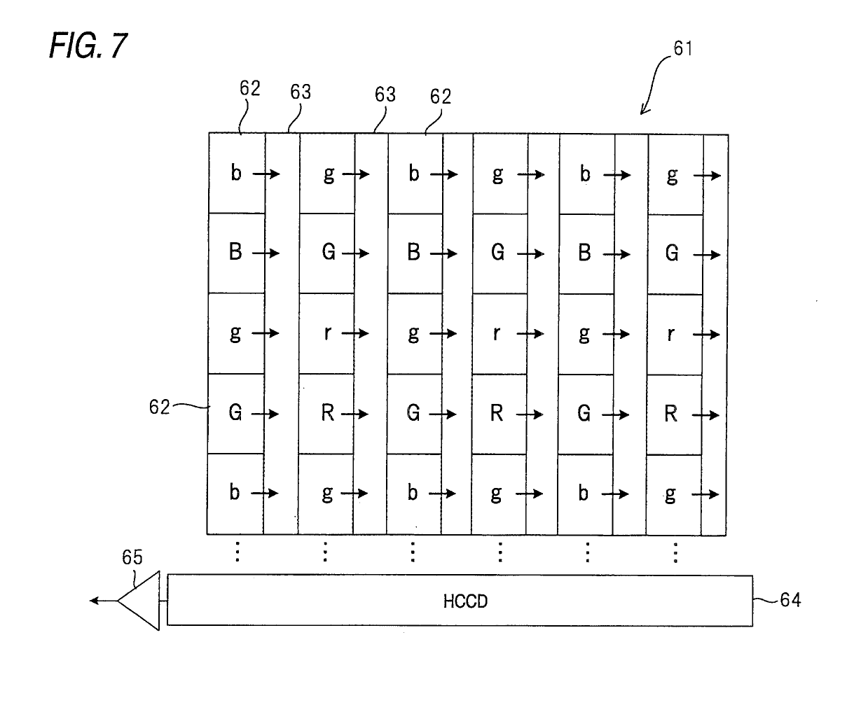

Further, in the above embodiments, description has been given based on the example in which the solid-state imaging device has the “honeycomb pixel arrangement” as shown in FIG. 2. The invention, however, is not limited to the solid-state imaging device having such a pixel arrangement, but may be applied to a solid-state imaging device 61 with pixels arranged in a square lattice as shown in FIG. 7 (the same as FIG. 1 of JP 2007-235656 A).

In this solid-state imaging device 61, pixels 62 at every other row are served as those for the long exposure time (pixels indicated by capital letters R, G, B) whereas the pixels at remaining every other row are served as those for the short exposure time (pixels indicated by small letters r, g, b). Color filters having the primary colors are arranged over the pixels for the long exposure time in the Bayer pattern. Also, color filters having three primary colors are arranged over the pixels for the short exposure time in the Bayer pattern.

Vertical charge transfer paths 63 are formed along the respective columns of the pixels. A horizontal charge transfer path 64 is formed along ends of the respective vertical charge transfer paths 63 in the transfer direction. At an output end of the horizontal charge transfer 64, an amplifier 65 is formed. Also in the imaging apparatus having this solid-state imaging device 61, by applying the embodiments shown in FIGS. 3 to 6, the object image having high quality and with a wide dynamic range can be obtained for scenes with different shooting conditions and exposure conditions.
[1] According to the embodiments of the invention, an imaging apparatus includes a solid-state imaging device and an imaging device driver. The solid-state imaging device includes a plurality of first pixels and a plurality of second pixels. The first pixels execute an imaging operation for a long exposure time. The second pixels execute an imaging operation for a short exposure time which overlaps with a part of the long exposure time. The first and second pixels are mixedly arranged in a two dimensional array. Charge transfer paths are formed along a plurality of pixel columns composed of the first and second pixels, respectively. A plurality of different drive controlling modes each controlling operation timings of start and end of exposure of the first pixels and operation timings of start and end of exposure of the second pixels are prepared in advance. The imaging device driver compares a length of an exposure time which is determined based on a shooting condition under which an object image is taken with a predetermined threshold value, selects one of the plurality of different drive controlling modes in accordance with the comparison result, and drives the solid-state imaging device in accordance with the selected mode.
[2] In the imaging apparatus of [1], the plurality of different drive controlling modes may include a first drive controlling mode and a second drive controlling mode. In the first drive controlling mode, the exposure of the first pixels and the exposure of the second pixels start at a same timing and the exposure of the first pixels and the exposure of the second pixels end at different timings. In the second drive controlling mode, the exposure of the first pixels and the exposure of the second pixels start at different timings and the exposure of the first pixels and the exposure of the second pixels end at a same timing.
[3] In the imaging apparatus of [2], if a length of the short exposure time is shorter than the predetermined threshold value, the imaging device driver may select the first drive controlling mode. If the length of the short exposure time is equal to or longer than the predetermined threshold value, the imaging device driver may select the second drive controlling mode.
[4] In the imaging apparatus of [2], a mechanical shutter may be provided ahead of the solid-state imaging device. Closing the mechanical shutter may end the exposure of the first pixels in the first drive controlling mode. Closing the mechanical shutter may end the exposure of the first pixels and the exposure of the second pixels in the second drive controlling mode.
[5] In the imaging apparatus of any one of [1] to [3], a mechanical shutter may be provided ahead of the imaging device. The mechanical shutter may be closed immediately after the exposure of the first pixels ends.
[6] In the imaging apparatus of [1], a mechanical shutter may be provided ahead of the imaging device. The plurality of different drive controlling modes may include a first drive controlling mode, a second drive controlling mode and a third drive controlling mode. In the first drive controlling mode, the exposure of the first pixels and the exposure of the second pixels start at a same timing and closing the mechanical shutter ends the exposure of the first pixels after the exposure of the second pixels ends. In the second drive controlling mode, the exposure of the first pixels and the exposure of the second pixels start at different timings and closing the mechanical shutter ends the exposure of the first pixels and the exposure of the second pixels. In the third drive controlling mode, the exposure of the first pixels and the exposure of the second pixels start at different timings, the exposure of the first pixels and the exposure of the second pixels end at a same timing, and thereafter the mechanical shutter is closed.
[7] In the imaging apparatus of [6], the imaging device driver may compare the short exposure time, which is determined when the object image is taken, with predetermined threshold values t1, t2 where t1<t2. If the short exposure time<t1, the imaging device driver may selects the first drive controlling mode. If t1≦the short exposure time<t2, the imaging device driver selects the third drive controlling mode. If t2≦the short exposure time, the imaging device driver selects the second drive controlling mode.
[8] According to the embodiments of the invention, there is provided a drive controlling method for an imaging apparatus including a solid-state imaging device. The solid-state imaging device has a plurality of first pixels and a plurality of second pixels. The first pixels execute an imaging operation for a long exposure time. The second pixels execute an imaging operation for a short exposure time which overlaps with a part of the long exposure time. The first and second pixels are mixedly arranged in a two dimensional array. Charge transfer paths are formed along a plurality of pixel columns composed of the first and second pixels, respectively. A plurality of different drive controlling modes each controlling operation timings of start and end of exposure of the first pixels and operation timings of start and end of exposure of the second pixels are prepared in advance. the drive controlling method includes comparing a length of an exposure time which is determined based on a shooting condition under which an object image is taken with a predetermined threshold value, and selecting one of the plurality of different drive controlling modes in accordance with the comparison result.

In accordance with each of the embodiments of the invention, the object image having few smears, high quality and a wide dynamic range can be obtained, thereby improving usability in extending the dynamic range.

The imaging apparatus and its drive controlling method according to the embodiments of the invention are advantageous in that an object image having high quality and a wide dynamic range can be obtained for scenes with different shooting conditions and exposure conditions. The invention can be usefully applied to digital electronic appliances such as a digital camera or video camera and a camera-equipped cellular phone.

What is claimed is:

1. An imaging apparatus comprising:
a solid-state imaging device including
a plurality of first pixels that execute an imaging operation for a long exposure time, and
a plurality of second pixels that execute an imaging operation for a short exposure time which overlaps with a part of the long exposure time, wherein
the first and second pixels are mixedly arranged in a two dimensional array,
charge transfer paths are formed along a plurality of pixel columns composed of the first and second pixels, respectively, and
a plurality of different drive controlling modes each controlling operation timings of start and end of exposure of the first pixels and operation timings of start and end of exposure of the second pixels are prepared in advance; and
an imaging device driver that compares a length of an exposure time which is determined based on a shooting condition under which an object image is taken with a predetermined threshold value, selects one of the plurality of different drive controlling modes in accordance with the comparison result, and drives the solid-state imaging device in accordance with the selected mode.

2. The imaging apparatus according to claim 1, wherein
the plurality of different drive controlling modes include
a first drive controlling mode in which the exposure of the first pixels and the exposure of the second pixels start at a same timing and the exposure of the first pixels and the exposure of the second pixels end at different timings, and
a second drive controlling mode in which the exposure of the first pixels and the exposure of the second pixels start at different timings and the exposure of the first pixels and the exposure of the second pixels end at a same timing

3. The imaging apparatus according to claim 2, wherein
if a length of the short exposure time is shorter than the predetermined threshold value, the imaging device driver selects the first drive controlling mode, and
if the length of the short exposure time is equal to or longer than the predetermined threshold value, the imaging device driver selects the second drive controlling mode.

4. The imaging apparatus according to claim 2, wherein
a mechanical shutter is provided ahead of the solid-state imaging device,
closing the mechanical shutter ends the exposure of the first pixels in the first drive controlling mode, and
closing the mechanical shutter ends the exposure of the first pixels and the exposure of the second pixels in the second drive controlling mode.

5. The imaging apparatus according to claim 1, wherein
a mechanical shutter is provided ahead of the imaging device, and
the mechanical shutter is closed immediately after the exposure of the first pixels ends.

6. The imaging apparatus according to claim 2, wherein
a mechanical shutter is provided ahead of the imaging device, and
the mechanical shutter is closed immediately after the exposure of the first pixels ends.

7. The imaging apparatus according to claim 3, wherein
a mechanical shutter is provided ahead of the imaging device, and
the mechanical shutter is closed immediately after the exposure of the first pixels ends.

8. The imaging apparatus according to claim 1, wherein
a mechanical shutter is provided ahead of the imaging device; and
the plurality of different drive controlling modes include
a first drive controlling mode in which the exposure of the first pixels and the exposure of the second pixels start at a same timing and closing the mechanical shutter ends the exposure of the first pixels after the exposure of the second pixels ends,
a second drive controlling mode in which the exposure of the first pixels and the exposure of the second pixels start at different timings and closing the mechanical shutter ends the exposure of the first pixels and the exposure of the second pixels, and
a third drive controlling mode in which the exposure of the first pixels and the exposure of the second pixels start at different timings, the exposure of the first pixels and the exposure of the second pixels end at a same timing, and thereafter the mechanical shutter is closed.

9. The imaging apparatus according to claim 8, wherein
the imaging device driver compares the short exposure time, which is determined when the object image is taken, with predetermined threshold values t1, t2 where t1<t2;
if the short exposure time <t1, the imaging device driver selects the first drive controlling mode,
if t1≦the short exposure time<t2, the imaging device driver selects the third drive controlling mode, and
if t2≦the short exposure time, the imaging device driver selects the second drive controlling mode.

10. A drive controlling method for an imaging apparatus including a solid-state imaging device having
a plurality of first pixels that execute an imaging operation for a long exposure time, and
a plurality of second pixels that execute an imaging operation for a short exposure time which overlaps with a part of the long exposure time, wherein
the first and second pixels are mixedly arranged in a two dimensional array,
charge transfer paths are formed along a plurality of pixel columns composed of the first and second pixels, respectively, and
a plurality of different drive controlling modes each controlling operation timings of start and end of exposure of the first pixels and operation timings of start and end of exposure of the second pixels are prepared in advance,
the method comprising:
comparing a length of an exposure time which is determined based on a shooting condition under which an object image is taken with a predetermined threshold value; and
selecting one of the plurality of different drive controlling modes in accordance with the comparison result.
